(19) United States
(12) Patent Application Publication
(10) Pub. No.: US 2005/0249296 A1
(43) Pub. Date: Nov. 10, 2005

(54) Incremental redundancy operation in a wireless communication network

(75) Inventors: Johan Axnas, Solna (SE); Tomas Jonsson, Lulea (SE); Rajaram Ramesh, Cary, NC (US); Jakob Singvall, Lund (SE)

Correspondence Address: NIXON & VANDERHYE, PC, 901 NORTH GLEBE ROAD, 11TH FLOOR, ARLINGTON, VA, 22203, US

(73) Assignee: Telefonaktiebolaget LM Ericsson (publ), Stockholm (SE)

(21) Appl. No.: 10/837,754

(22) Filed: May 4, 2004

(51) Int. Cl. H04L 27/28

(52) U.S. Cl. 375/260

(57) ABSTRACT

The invention is based on the recognition that optimal or at least improved performance can be obtained by providing relevant information that enables selection of which sub-block to set forth for transmission from the transmitting side to the receiving side. The idea according to the invention is to measure, for at least one data block, the reception quality of a number of received sub-blocks, and select which sub-block to set forth for transmission from the transmitting side based on the measured sub-block reception quality. For example, when all or several sub-blocks of a given data block have been received but the data block can still not be successfully decoded, it would normally be best to retransmit the sub-block that has the lowest quality. This generally increases the probability of successful decoding of the data block, thus increasing the throughput and reducing the delay.

### TECHNICAL FIELD OF THE INVENTION

The present invention generally relates to wireless communications and in particular to the use of incremental redundancy schemes in wireless networks such as radio communication networks.

### BACKGROUND OF THE INVENTION

There is a continuously growing demand for improved throughput in wireless communication networks. Incremental redundancy, which is sometimes referred to as Hybrid ARQ (Automatic Repeat reQuest), is an advanced technique for improving the throughput performance of a wireless link, and particularly interesting for packet-oriented high-speed wireless communications.

In the basic incremental redundancy scheme, each data block is encoded with redundancy and punctured into a number of versions, often referred to as sub-blocks, of the encoded data block for transmission from the transmitting side to the receiving side, as schematically illustrated in FIG. 1. The sub-blocks can be produced all at once and stored for use as and when required by the ARQ scheme, or alternatively each particular version or sub-block is produced dynamically upon request. The sub-blocks are transmitted over the air interface. If the receiving side can not decode the data block correctly based on the first received sub-block a Negative Acknowledgement (NACK) is sent to the transmitting side. If possible, soft values of the first sub-block may be stored in memory at the receiving side. In response to the NACK, the next sub-block will be sent. The receiving side utilizes stored soft values of the first sub-block and combines them with the soft values of the presently received sub-block to increase the chances of successful decoding. This procedure continues until the data block is correctly decoded, or all sub-blocks have been transmitted. If the combination of all sub-blocks still can not be decoded, the sub-blocks will be transmitted from the beginning once again until the data block is successfully decoded. The sub-blocks are thus transmitted incrementally to gradually increase the rate of redundancy in the received signal information. When a data block is successfully decoded, the receiving side transmits a positive acknowledgement (ACK) to the transmitting side. The ACK/NACK feedback simply indicates whether or not the data block has been received and decoded correctly.

Normally, the receiving side must know the sequence numbers before combining separate sub-block transmissions. Each transmitted sub-block is therefore typically identified by a sequence number and preferably also a sub-block number, both of which are contained in a header that is normally coded separately from the data. If a header error should occur, then the corresponding sub-block will be lost. In short, the incremental redundancy soft combining generally leads to a higher probability of correct decoding.

Although the traditional incremental redundancy schemes have indeed improved the performance of wireless communications, there is still a general demand for even better incremental redundancy operation as well as increased throughput and reduced delay in wireless networks.

### RELATED ART

Reference [1] relates to a stop-and-wait hybrid ARQ scheme with incremental data packet combining, and suggests the use of three signaling commands: ACK, NACK and LOST. The suggested stop-and-wait ARQ scheme is used for data packet transmissions where a data packet may include a first type of bits and a second type of bits, the first type of bits being more important than the second type of bits, and where a negatively acknowledged packet triggers retransmission of the second less important type of bits. When absence of a data packet is detected, a LOST signal is sent to the transmitter rather than a NACK, and the transmitter initiates a first retransmission of the first more important types of bits of the data packet in response to the LOST signal.

References [2, 3] are working documents relating to hybrid ARQ incremental redundancy schemes for HSDPA (High Speed Downlink Packet Access).

Reference [4] relates to RLC/MAC simulation for GPRS and EDGE and schematically describes incremental redundancy with examples of coding and puncturing for various modulation and coding schemes.

### SUMMARY OF THE INVENTION

It is a general object of the present invention to improve the throughput performance and/or and reduce delay in wireless communication networks. In particular, it is desirable to provide an improved scheme for incremental redundancy operation for wireless communications.

It is also a general object to improve the utilization of the memory on the receiving side.

Yet another object is to provide a method and system for improved incremental redundancy operation in a wireless communication network.

It is also an object to provide a receiving node as well as a transmitting node supporting the improved incremental redundancy scheme.

These and other objects are met by the invention as defined by the accompanying patent claims.

In the traditional incremental redundancy schemes the sub-blocks are transmitted in a given order, and if the combination of all sub-blocks can still not be decoded, the sub-blocks will be transmitted from the beginning once again until the data block can be decoded. The only feedback reported to transmitting side is generally a single bit (ACK/NACK) indicating whether or not the entire data block has been correctly decoded.

The invention is based on the recognition that optimal or at least improved performance can be obtained by providing relevant information that enables selection of which sub-block to set forth for transmission from the transmitting side to the receiving side. The idea according to the invention is to measure, for at least one data block, the reception quality of a number of received sub-blocks, and select which sub-block to set forth for transmission from the transmitting side based on the measured sub-block reception quality.

For example, when all or several sub-blocks of a given data block have been received but the data block can still not be successfully decoded, it would normally be best to retransmit the sub-block that has the lowest quality. This generally increases the probability of successful decoding of the data block, thus increasing the throughput and reducing the delay. If the considered data block can be decoded after retransmission, the corresponding sub-blocks can be removed from the receiver memory, allowing room for soft values of new data blocks. This also improves the utilization of the memory on the receiving side.

The selection of sub-block may be performed by the receiving side, in which case a feedback message is sent back to the transmitting side indicating that the receiving side wants the selected sub-block to be transmitted. The transmitting side may then transmit the selected sub-block from the transmitting side to the receiving side in response to the feedback message. Alternatively, the receiving side transmits information representative of the measured sub-block reception quality to the transmitting side, in which case the selection of sub-block can be performed by the transmitting side in response to the quality information.

The reception quality may for example be taken as any of the demodulation/decoding metrics available or determined based on explicit measurements of bit error rate, SNR (Signal-to-Noise ratio), SIR (Signal-to-Interference Ratio), BLEP (Block Error Probability) or any combination thereof.

The feedback message from the receiving side is preferably an extended acknowledgement feedback message that comprises at least two bits representing which sub-block to set forth for transmission. Instead of transmitting a single ACK/NACK bit indicating whether a data block has been decoded or not, the invention thus recommends an extended acknowledgement feedback that enables indication of which sub-block to transmit next from the transmitting side to the receiving side.

Such an extended acknowledgement feedback message has multiple potential bit patterns, a unique bit pattern preferably being assigned for each sub-block to indicate a desire for transmission of that sub-block The extended acknowledgement feedback message typically has a further potential bit pattern indicating that an entire data block has been correctly received and decoded, corresponding more or less to the traditional ACK.

In a further aspect of the invention, multiple feedback messages are aggregated in a single aggregated bitmap. This actually means that the receiving side transmits to the transmitting side an aggregated message for multiple data blocks at a time to enable indication, for each data block, which sub-block of the data block to set forth for transmission to the receiving side. In particular, this opens up for more efficient use of incremental redundancy based on selective repeat ARQ. Preferably, bitmap compression may be applied to the aggregated bitmap to reduce the number of bits that have to be sent back to the transmitting side

The invention offers the following advantages:
Increased probability of successful decoding;
Improved utilization of the memory;
Reduced number of retransmissions;
Increased throughput; and
Reduced delay.

Other advantages offered by the present invention will be appreciated upon reading of the below description of the embodiments of the invention.

### BRIEF DESCRIPTION OF THE DRAWINGS

The invention, together with further objects and advantages thereof, will be best understood by reference to the following description taken together with the accompanying drawings, in which:

FIG. 1 is a schematic overview of basic incremental redundancy scheme according to the prior art;

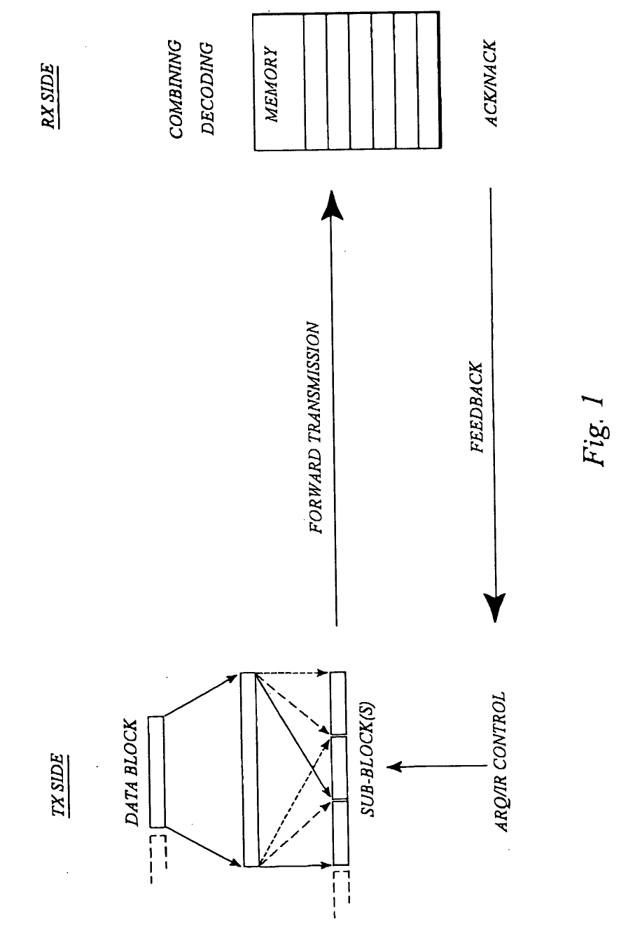

FIG. 2 is a schematic flow diagram illustrating a method for incremental redundancy operation according to a preferred basic embodiment of the invention;

FIG. 3 is a schematic flow diagram illustrating a method for incremental redundancy operation on the receiving side according to a first exemplary embodiment of the invention;

FIG. 4 is a schematic flow diagram illustrating a method for incremental redundancy operation on the receiving side according to a second exemplary embodiment of the invention;

FIG. 5 is a schematic flow diagram illustrating a method for incremental redundancy operation on the transmitting side according to a preferred embodiment of the invention;

FIG. 6 is a schematic diagram illustrating an example of redundancy encoding and reduction/puncturing according to an exemplary embodiment of the invention;

FIG. 7 is a schematic block diagram of an ARQ/IR transmitter according to an exemplary embodiment of the invention;

FIG. 8 is a schematic block diagram of an ARQ/IR transmitter according to an alternative embodiment of the invention; and

FIG. 9 is a schematic block diagram of an ARQ/IR receiver according to an exemplary embodiment of the invention.

### DETAILED DESCRIPTION OF EMBODIMENTS OF THE INVENTION

Throughout the drawings, the same reference characters will be used for corresponding or similar elements.

As previously mentioned, in most traditional incremental redundancy ARQ schemes, each of a number of data blocks is normally encoded with redundancy and then punctured into one or more reduced versions, generally referred to as sub-blocks, of the encoded data block, for transmission from the transmitting side to the receiving side. However, instead of transmitting a single ACK/NACK bit indicating whether a data block has been decoded or not, the idea according to the invention is to measure, for at least one data block, the reception quality of a number of received sub-blocks, and select which sub-block to set forth for transmission from the transmitting side based on the measured sub-block reception quality.

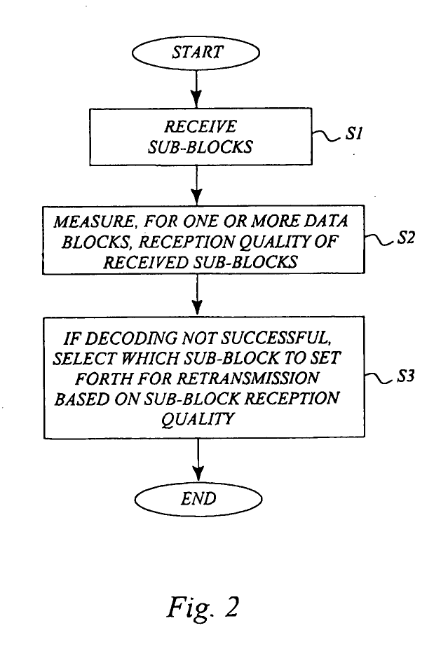

As indicated in the basic flow diagram of FIG. 2, a number of sub-blocks are received by the intended receiver in step S1. In step S2, the reception quality of each of the considered sub-blocks is measured. This is normally performed for one or more data blocks, as the corresponding sub-blocks are received. The receiver attempts to decode the data blocks based on the received sub-blocks. If the decoding is not successful, a selection of which sub-block to set forth for transmission is made in step S3 based on measured sub-block quality. The selection of sub-block may be performed by the receiving side, and then a feedback message or acknowledgement is sent back to the transmitting side indicating that the receiving side wants the selected sub-block to be transmitted. Alternatively, the receiving side transmits information representative of the measured sub-block reception quality to the transmitting side, letting the transmitter select which sub-block to transmit in response to the received quality information.

The quality of the received sub-blocks may for example be determined in connection with the demodulation and/or decoding, using any known metric to estimate how far the received bit sequence is from a correct word. Other ways of estimating the reception quality or level of reliability are also possible, including bit error rate estimation and measuring signal-to-noise ratio (SNR), signal-to-interference-ratio (SIR), block error probability (BLEP) or any combination thereof.

The sub-blocks of a data block may a priori have substantially equal importance for decoding the data block. It may however be the case that some sub-blocks of a data block have significantly higher a priori importance for the decoding. In the latter case, it may be beneficial to consider both the sub-block reception quality and the a priori importance when selecting which sub-block to set forth for retransmission.

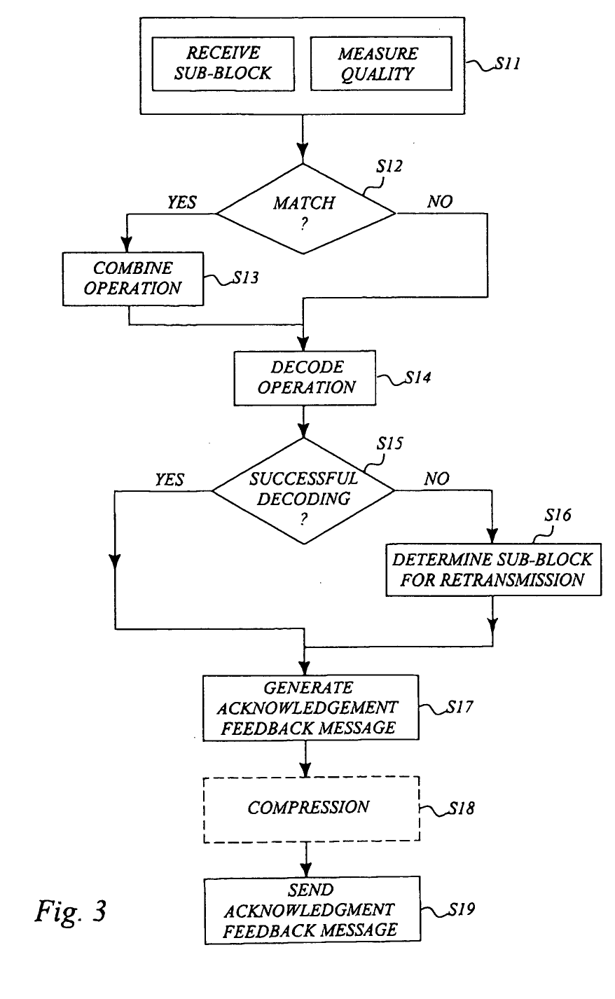

For a better understanding, the invention will now be described by way of example with reference to the flow diagrams of FIGS. 3-5.

FIG. 3 is a schematic flow diagram illustrating a method for incremental redundancy operation on the receiving side according to a first exemplary embodiment of the invention.

In step S11, a sub-block is received and the reception quality, i.e. the level of reliability (also referred to as the level of soft energy), of the received sub-block is measured and stored in memory, preferably indexed by sequence number and sub-block number. In step S12, it is then investigated whether the sub-block belongs to a new data block for which no soft information is stored in the receiver memory. This is normally performed by processing the header information associated with the encoded sub-block to find the corresponding sequence number and sub-block number. This information is then compared to the sequence numbers associated with the soft information stored in the receiver memory. If a match is found (YES), the receiver utilizes already stored soft values and combines them with the soft values of the presently received sub-block in step S13 to increase the chances of successful decoding. In step S14, the decode operation is performed. If the received sub-block belongs to a new data block, and there is no match (NO) with any sequence number in the receiver memory, the decode operation is performed directly without any soft combining.

In step S15, it is investigated whether the decoding was successful or not. If the receiving side could not decode the data block correctly based on the available sub-block information (NO), it is determined in step S16 which sub-block to set forth for transmission based on the measured reception quality of the sub-blocks corresponding to the considered data block. This is particularly interesting when all sub-blocks of a data block have already been received, or when the receiver memory is full. If it is clear in step S15, that the decoding was successful, this is noted and an appropriate acknowledgement feedback message will be generated.

In step S17, depending on the decoding and/or the sub-block quality results an appropriate acknowledgement feedback message is generated for the data block in question. In addition to the possibility to indicate whether the decoding was successful or not, the acknowledgement feedback message proposed by the invention is preferably extended to enable indication of which sub-block to set forth for retransmission.

Optionally, multiple extended acknowledgement feedback messages can be aggregated into an aggregated acknowledgement bitmap and bitmap compression can be applied, as indicated in step S18. In step S19, the extended acknowledgement feedback message for the considered data block is transmitted to the transmitting side, either separately or together with other feedback messages, in compressed form or not. The steps S11-S19 are normally repeated for each of a number of received sub-blocks.

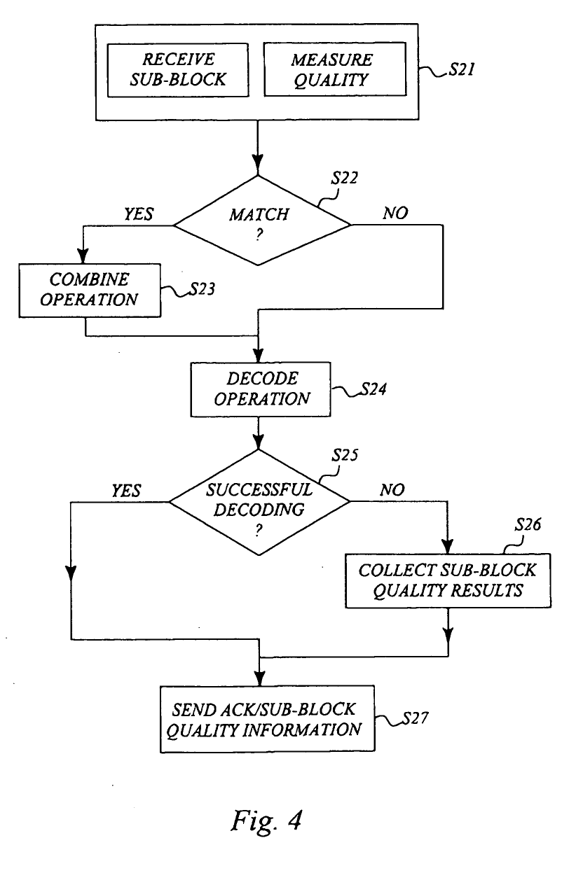

FIG. 4 is a schematic flow diagram illustrating a method for incremental redundancy operation on the receiving side according to a second exemplary embodiment of the invention. The steps S21-S25 more or less directly correspond to the steps S11-S15 described in connection with FIG. 3. In step S26, if the receiving side could not decode the data block correctly based on the available sub-block information (NO), sub-block quality results for the considered data block is collected. Next, in step S27, information representative of the sub-block quality is sent to the transmitting side to help the transmitter prioritize among the different sub-blocks of the considered data block. The steps S21-S27 are typically repeated for each of a number of received sub-blocks.

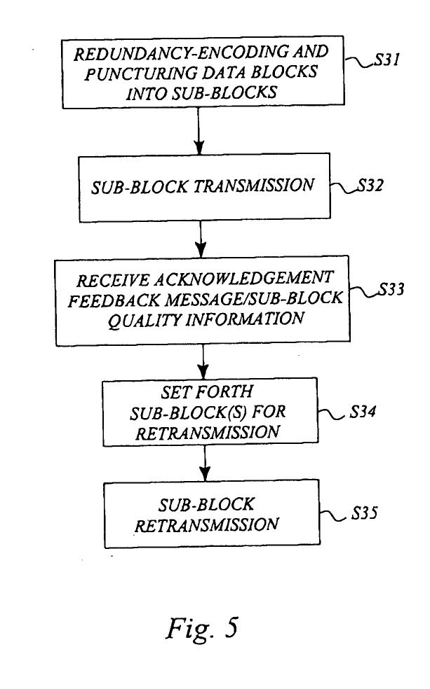

FIG. 5 is a schematic flow diagram illustrating a method for incremental redundancy operation on the transmitting side according to a preferred embodiment of the invention.

In step S31, a number of data blocks are redundancy-encoded and punctured or otherwise reduced into encoded sub-blocks on the transmitting side. In step S32, the encoded sub-blocks are transmitted to the receiving side. Subsequently, in step S33, the transmitter receives an acknowledgement feedback message and/or sub-block quality information for each of a number of data blocks. In step S34, the transmitter prepares, for each considered data block, the sub-block indicated in the corresponding acknowledgement feedback message for transmission and/or selects a sub-block for retransmission based on the corresponding sub-block quality information. Retransmission of the selected sub-block or blocks is then initiated in step S35.

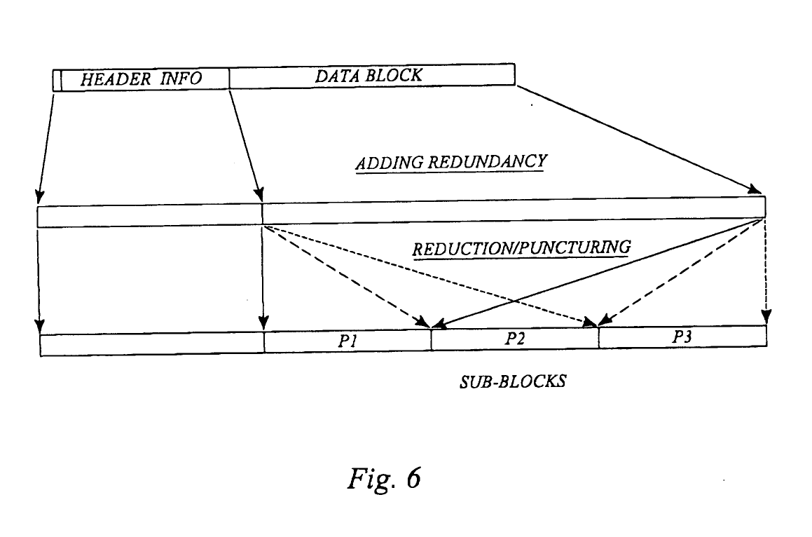

FIG. 6 schematically illustrates an example of redundancy encoding and puncturing according to an exemplary embodiment of the invention. For example, a normal RLC/MAC (Radio Link Control /Medium Access Control) block includes header information and payload data. For error detection and/or correction purposes, additional redundant information is added to the header and data parts, e.g. by convolutional encoding or any other suitable redundancy-encoding scheme. The coded information is then normally punctured or otherwise reduced to form smaller entities of data, called sub-blocks or versions, that can be transmitted incrementally to gradually increase the rate of redundancy in the received data. This generally corresponds to Hybrid-ARQ-II. The sub-blocks can be produced all at the same time and stored for use as and when required by the ARQ scheme, or alternatively each particular version or sub-block is produced dynamically upon request. Both overlapping sub-blocks and non-overlapping sub-blocks may be produced. In this particular example, three different sub-blocks or versions P1, P2 and P3 can be produced. Normally, the receiving side must know the sequence numbers before combining separate sub-block transmissions. Each transmitted sub-block is therefore typically identified by a sequence number and preferably also a sub-block number, both of which are contained in the header that is normally coded separately from the data. If a header error should occur, then the corresponding sub-block will be lost.

Hybrid-ARQ-III also belongs to the class of incremental redundancy schemes. However, with H-ARQ-III, each retransmission is self-decodable. Chase combining, which is also referred to as H-ARQ-III with one redundancy version, involves retransmission of the same coded data packet. The receiver combines multiple copies of the transmitted packet weighted by the received SNR to obtain a diversity gain. In H-ARQ-III with multiple redundancy version, different puncture bits are typically used in each retransmission.

In the following, the invention will be described with reference to an exemplary implementation of an extended acknowledgement feedback especially adapted for IR schemes with three puncturing patterns/sub-blocks. The invention is however not limited to the use of three puncturing patterns, as readily understood by the skilled person.

The extended acknowledgement feedback is preferably implemented by transmitting, for each of a number of data blocks, an extended acknowledgment feedback message comprising two (or more) bits representing the status of the data block at the receiving side. The extended acknowledgement message typically has a number of unique potential bit patterns, a unique bit pattern preferably being assigned for each sub-block to indicate a desire for transmission of that sub-block. The extended acknowledgement feedback message typically has a further potential bit pattern indicating that an entire data block has been correctly received and decoded. This more or less corresponds to the traditional ACK.

If no more than three puncturing patterns are used, then two bits may be sufficient as will be exemplified below. If more than three puncturing patterns are used, then it may be necessary/useful to employ more than two bits for reporting the status of the data block.

In an exemplary embodiment of the invention, two bits are used for reporting the status of each data block, and more specifically to enable indication of which sub-block that is desired for retransmission.
00—The data block has been received and decoded correctly.
01—Transmission of P1 desired.
10—Transmission of P2 desired.
11—Transmission of P3 desired.

For example, when all sub-blocks of a given data block have been received but the data block can still not be successfully decoded, it would normally be best to retransmit the sub-block that has the lowest quality in order to increase the probability of successful decoding of the data block. Selecting the sub-block that has the lowest quality, i.e. the lowest level of soft energy in the receiver memory, is recommendable since such a sub-block would probably benefit the most from a retransmission. As previously mentioned, the reception quality may be taken for example as any of the demodulation/decoding metrics available or determined based on explicit measurements of bit error rate, SNR, SIR, BLEP or any combination thereof.

Another scenario is when the receiver memory is full, and for example sub-blocks P1, P2 are already in memory, but not sub-block P3. In this case, it would be best to select the sub-block among sub-blocks P1 and P2 that has the lowest quality, rather than selecting sub-block P3 since the receiver would not be able to store P3 anyway. However, it would still be possible to add more soft value energy to a sub-block already stored in memory.

In general, adding more soft value energy increases the likelihood of successful decoding, thus improving the utilization of the receiver memory, increasing the throughput, and reducing the delay.

It may also be interesting to consider not only the reception quality but also the a priori importance of the sub-blocks when selecting which sub-block to retransmit.

For further enhancement of the proposed schemes, it may even be desirable to indicate priority among multiple sub-blocks, i.e. to indicate not only which sub-block that has top priority (preferred) from a reception quality point of view but also which sub-block that has second priority and so forth. The transmitter may then select which sub-block to set forth for transmission at least partly based on the indication of bow sub-blocks are prioritized, and enables the transmitter to also consider transmitter-side specific information. This could be useful if a certain sub-block is easier for the transmitter to transmit than the preferred sub-block, for example because the former sub-block has already been produced and stored in cache for easy retrieval. Normally such an extended indication requires further bits for representing the priorities of two or more sub-blocks of a data block.

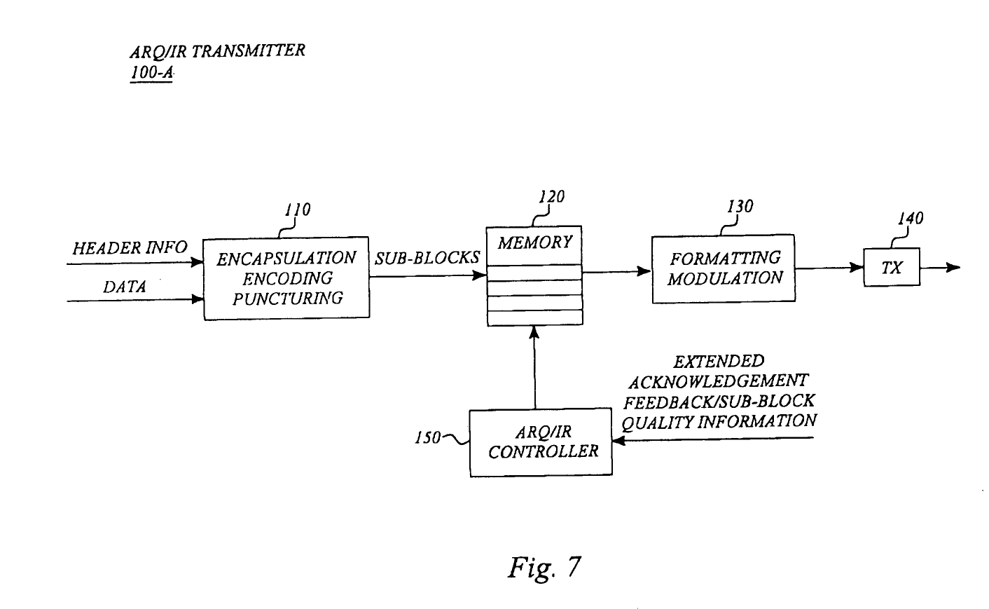

FIG. 7 is a schematic block diagram of an ARQ/IR transmitter according to an exemplary embodiment of the invention. The ARQ/IR transmitter 100-A basically comprises an encapsulation, encoding and puncturing module 110, a memory buffer 120 for sub-blocks, a formatting and modulation module 130, a transmission module 140 and an ARQ/IR controller 150. In response to header information and payload data, module 110 takes care of encapsulation, encodes data and header with additional redundant information, and punctures or otherwise reduces the encoded information into sub-blocks. For example, data may be encoded by a rate ⅓ convolutional code. For any incremental redundancy based ARQ, it is important to have well-protected header information, and therefore the header information usually has a strong code on it and is also normally protected with its own CRC (Cyclical Redundancy Check). The encoded sub-blocks together with relevant header information are then stored in the memory buffer 120, awaiting transmission under the control of the ARQ/IR controller 150. As explained above, the ARQ/IR controller preferably operates based on extended acknowledgement feedback for each of a number of data blocks. In response to an extended acknowledgement feedback message for a given packet data unit or data block, the ARQ/IR controller 150 finally decides which encoded version or sub-block that is to be transmitted to the receiving side. The ARQ/IR controller 150 then picks out the relevant encoded sub-block from the memory buffer 120 and transfers the sub-block to the formatting and modulation module 130. Finally, the encoded and modulated sub-block is forwarded to the transmission module 140 for transmission to a receiving node such as a mobile terminal. Alternatively, the ARQ/IR controller 150 receives information on the quality of received sub-blocks of a given data block, and decides which sub-block to set forth for transmission based on this information.

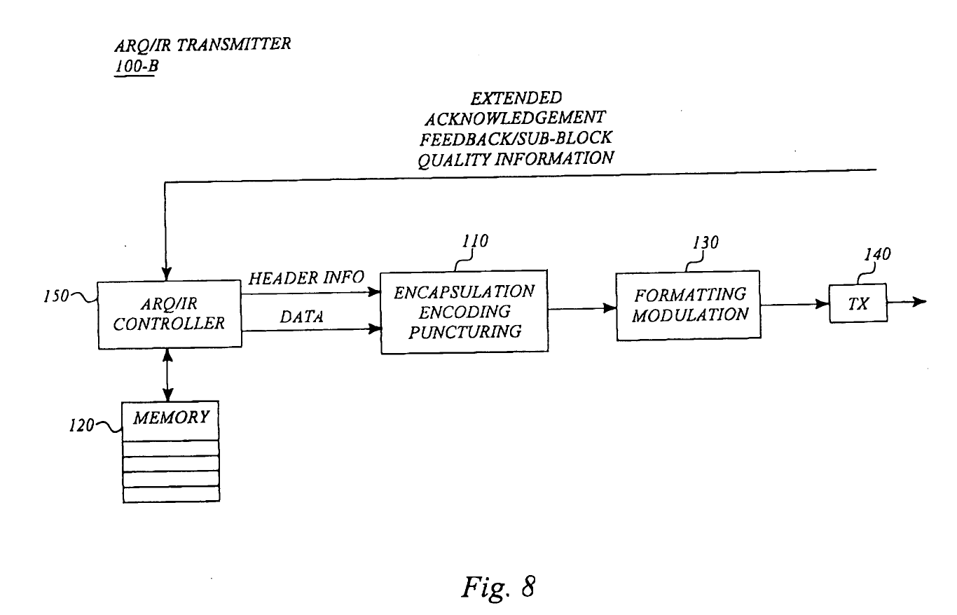

FIG. 8 is a schematic block diagram of an ARQ/IR transmitter according to an alternative embodiment of the invention. The ARQ/IR transmitter 100-B has the same or similar components as the ARQ/FIR transmitter of FIG. 7, but rather than storing multiple versions or sub-blocks of a data block, the transmitter of FIG. 8 dynamically selects which sub-block to produce and prepare for transmission. This has the advantage of reducing the memory requirements of the transmitter. As previously described, the ARQ/IR controller 150 preferably operates based on extended acknowledgement feedback for each of a number of data blocks. In response to an extended acknowledgement feedback message for a given packet data unit or data block, the ARQ/IR controller 150 finally decides which encoded version or sub-block that is to be transmitted to the receiving side. However, in the implementation of FIG. 8, the ARQ/IR controller 150 controls transfer of header information and data from the memory buffer 120 to module 110, and also commands the encoding and puncturing module 110 to use a selected puncturing scheme, thus producing a particular encoded version or sub-block of the data block. The produced sub-block is then transferred to the formatting and modulation module 130, and finally the encoded and modulated sub-block is forwarded to the transmission module 140 for transmission. In the same way as for the transmitter of FIG. 7, the ARQ/IR controller 150 of FIG. 8 may alternatively select which sub-block to set forth for transmission based on information on the quality of received sub-blocks of a given data block.

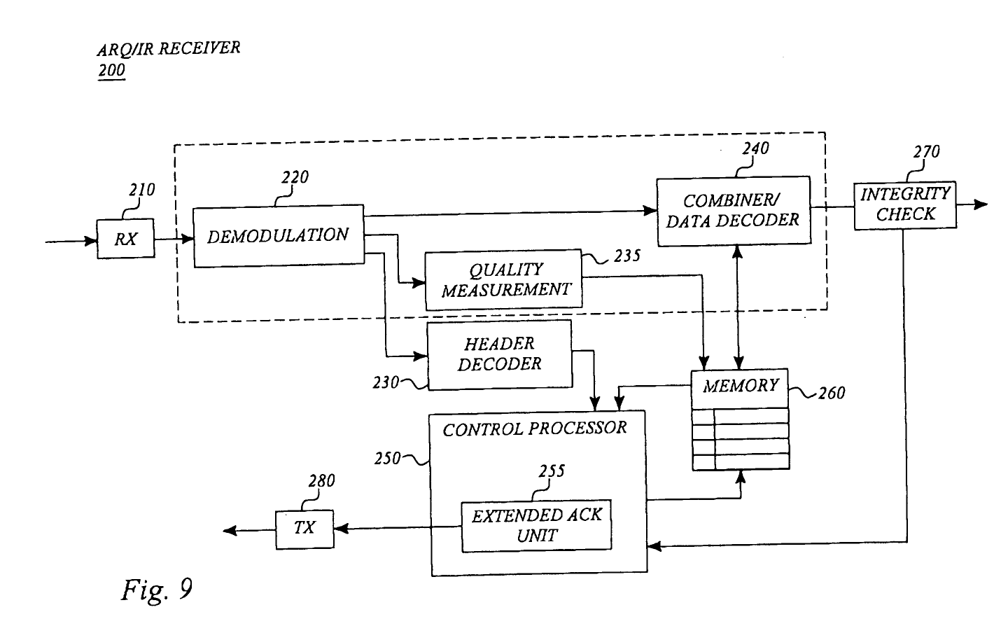

FIG. 9 is a schematic block diagram of an ARQ/IR receiver according to an exemplary embodiment of the invention. The ARQ/IR receiver 200 basically comprises a receiver module 210, a demodulation module 220, a header decoder 230, a quality measurement module 235, a combiner/data decoder 240, a control processor 250, an incremental redundancy memory 260, a data integrity check module 270 and a transmission module 280. The encoded and modulated sub-blocks are received by the receiver module 210 and demodulated in demodulation module 220. The header information is decoded in the header decoder 230, and the header information including sequence number information is transferred to the control processor 250. The quality measurement module 235 measures the reception quality, or the level of reliability of each received sub-block and stores the quality result in memory, preferably in the IR memory 260, indexed with the corresponding sequence number and sub-block number The quality measurements module 235 may be implemented separately or as an integrated part of the demodulation unit 220 and/or the decoder 240. As indicated by the dashed lines in FIG. 9, the quality measurements may be implemented as an integrated part of the normal operations of the demodulation unit 220 and/or decoder 240. In this case, the reception quality may be taken as any of the reliability/quality metrics available from the demodulator/decoder. The received and demodulated sub-blocks are forwarded to the combiner/decoder 240 for decoding. The decoding process may include soft combining of presently received bits with previously received soft bits associated with the same data block. For each received sub-block, the control processor 250 compares the corresponding sequence number with the sequence numbers of the sub-blocks held in memory 260. If there is a match, the control processor 250 transfers soft sub-block information corresponding to the same sequence number to the combiner/decoder 240, which combines the stored sub-block information with the received soft sub-block information, and then performs decoding operations. If the decoding is not successful, the receiver's IR memory 260 is updated with the received soft information and/or the combined information, indexed with the corresponding sequence number and sub-block number. If the decoding is successful, the data integrity of the data block is checked, e.g. by performing a CRC check, in the data integrity check module 270. If the CRC check is passed, the data is normally forwarded to higher layer functions on the receiving side. The control processor 250 is also informed of the result of the data integrity check. In this particular example, the control processor 250 includes an extended acknowledgement unit 255, which based on the result of the data integrity check and/or information on the quality of the received sub-blocks of a given data block preferably generates an appropriate extended acknowledgement feedback message for the data block. If the data block is successfully decoded, the acknowledgement feedback message will indicate this. Otherwise, the acknowledgement feedback message will somehow indicate which sub-block that is desired for retransmission, as determined based on the sub-block quality information. The extended acknowledgement feedback message is transferred to the transmission module 280 for transmission to the transmitting side. Alternatively, the sub-block quality information is reported back to the transmitting side to help the transmitter prioritize among the sub-blocks of a given data block.

In a particular example, the transmitter 100 preferably operates based on a selective repeat (SR) ARQ scheme, with a windowing mechanism that allows a whole batch of packet data units to be sent to the receiver. The receiver 200 is then typically polled for feedback, and the receiver may then prepare and transmit an aggregated acknowledgement bitmap that includes extended acknowledgement information for each packet of the batch. When it can be expected that the bitmap will include a lot of ACK indications (00) and occasionally indicate other bit patterns, it may be useful to apply bitmap compression, for example using run-length encoding, to reduce the number of bits that have to be sent back to the transmitting side.

The invention is however generally applicable to incremental redundancy schemes including Hybrid ARQ schemes, even stop-and-wait (SW) ARQ. The invention has been found especially suitable for EGPRS (Enhanced General Packet Radio Service) applications, but can also be advantageously applied to other wireless standards such as W-CDMA, CDMA 2000, and IEEE 802.16 (WiMax)

The embodiments described above are merely given as examples, and it should be understood that the present invention is not limited thereto. Further modifications, changes and improvements which retain the basic underlying principles disclosed and claimed herein are within the scope of the invention.

### REFERENCES

[1] International Patent Publication WO 02/23792 A1, Mar. 21, 2002.
[2] TSGR1#17(00)1382; Lucent Technologies; Nov. 21-24, 2000.
[3] TSGR1#18(01)0124(Text Proposal for TR 25.848); Lucent Technologies; Jan. 15-19, 2001.
[4] RLC/MAC Simulation for GPRS and EDGE, P.Schefczik, Global Wireless Systems Research, Feb. 19, 1999.

1. A method for incremental redundancy operation in a wireless communication network, at least one data block being encoded with redundancy and reduced into sub-blocks for transmission from a transmitting side to a receiving side, said method comprising the steps of:
measuring, for said at least one data block, the reception quality of a number of received sub-blocks; and
selecting, for said at least one data block, which sub-block to set forth for transmission from the transmitting side based on the measured sub-block reception quality.

2. The method according to claim 1, wherein information representative of said sub-block reception quality is transmitted from the receiving side to the transmitting side, and said step of selecting which sub-block to set forth for transmission is performed on the transmitting side.

3. The method according to claim 1, wherein said step of selecting which sub-block to set forth for transmission is performed on the receiving side, and said receiving side transmits a feedback message, for said at least one data block, to the transmitting side indicating that the receiving side wants the selected sub-block to be retransmitted.

4. The method according to claim 3, further comprising the step of transmitting the selected sub-block from the transmitting side to the receiving side in response to the feedback message.

5. The method according to claim 3, wherein said feedback message is an extended acknowledgement feedback message that comprises at least two bits representing which sub-block to set forth for transmission.

6. The method according to claim 5, wherein said extended acknowledgement feedback message has multiple potential bit patterns, a unique bit pattern being assigned for each sub-block to indicate a desire for transmission of that sub-block.

7. The method according to claim 6, wherein said extended acknowledgement feedback message has a further potential bit pattern indicating that an entire data block has been correctly received and decoded.

8. The method according to claim 1, wherein said step of selecting which sub-block to set forth for transmission comprises the step of determining, when all sub-blocks of a data block have been received but the data block can still not be successfully decoded, which of the sub-blocks to retransmit based on the reception quality of the sub-blocks.

9. The method according to claim 3, wherein a feedback message is transmitted for each of a number of data blocks, and the feedback messages for all these data blocks arc aggregated into a single aggregated bitmap.

10. The method according to claim 9, further comprising the step of applying bitmap compression to the aggregated bitmap.

11. The method according to claim 1, wherein the sub-blocks of said at least one data block a priori have substantially equal importance for decoding the data block.

12. The method according to claim 1, wherein the sub-blocks of said at least one data block a priori have different importance for decoding the data block, and said step of selecting which sub-block to set forth for transmission from the transmitting side is also based on the a priori importance for decoding.

13. The method according to claim 2, wherein said information representative of said sub-block reception quality comprises an indication of how sub-blocks are prioritized with respect to reception quality, and said step of selecting which sub-block to set forth for transmission is performed by the transmitting side at least partly based on the indication of how sub-blocks are prioritized.

14. A system for improved incremental redundancy in a wireless communication network, at least one data block being encoded with redundancy and reduced into sub-blocks for transmission from a transmitting side to a receiving side, said system comprising:
means for measuring, for said at least one data block, the reception quality of a number of received sub-blocks; and
means for selecting, for said at least one data block, which sub-block to set forth for transmission from the transmitting side based on the measured sub-block reception quality.

15. The system according to claim 14, further comprising means for transmitting information representative of said sub-block reception quality from the receiving side to the transmitting side, and wherein said means for selecting which sub-block to set forth for transmission is provided on the transmitting side.

16. The system according to claim 14, wherein said means for selecting which sub-block to set forth for transmission is provided on the receiving side, and said system further comprises means for transmitting a feedback message, for said at least one data block, from the receiving side to the transmitting side indicating that the receiving side wants the selected sub-block to be retransmitted.

17. The system according to claim 16, further comprising means for transmitting the selected sub-block from the transmitting side to the receiving side in response to the feedback message

18. The system according to claim 16, wherein said feedback message is an extended acknowledgement feedback message that comprises at least two bits representing which sub-block to set forth for transmission.

19. The system according to claim 18, wherein said extended acknowledgement feedback message has multiple potential bit patterns, a unique bit pattern being assigned for each sub-block to indicate a desire for transmission of that sub-block.

20. The system according to claim 19, wherein said extended acknowledgement feedback message has a further potential bit pattern indicating that an entire data block has been correctly received and decoded.

21. The system according to claim 14, wherein said means for selecting which sub-block to set forth for transmission comprises means for determining, when all sub-blocks of a data block have been received but the data block can still not be successfully decoded, which of the sub-blocks to retransmit based on the reception quality of the sub-blocks.

22. The system according to claim 16, wherein said system comprises means for transmitting a feedback message for each of a number of data blocks, and means for aggregating the feedback messages for all these data blocks into a single aggregated bitmap.

23. The system according to claim 22, further comprising means for applying bitmap compression to the aggregated bitmap.

24. The system according to claim 14, wherein the sub-blocks of said at least one data block a priori have substantially equal importance for decoding the data block.

25. The system according to claim 14, wherein the sub-blocks of said at least one data block a priori have different importance for decoding the data block, and said means for selecting which sub-block to set forth for transmission from the transmitting side operates also based on the a priori importance for decoding.

26. The system according to claim 15, wherein said information representative of said sub-block reception quality comprises an indication of how sub-blocks are prioritized with respect to reception quality, and said means for selecting which sub-block to set forth for transmission operates at least partly based on the indication of how sub-blocks are prioritized.

27. A receiving node for incremental redundancy operation in a wireless communication network, said receiving node comprising:
means for receiving encoded sub-blocks from the transmitting side to decode, if possible, at least one data block, said at least one data block initially being encoded with redundancy and reduced into sub-blocks;
means for measuring, for said at least one data block, the reception quality of a number of received sub-blocks;
means for selecting, for said at least one data block, which sub-block to set forth for transmission from the transmitting side based on the measured sub-block reception quality, and
means for transmitting, for said at least one data block, a feedback message to the transmitting node indicating that the receiving node wants the selected sub-block to be retransmitted.

28. The receiving node according to claim 27, wherein said feedback message is an extended acknowledgement feedback message that comprises at least two bits representing which sub-block to set forth for transmission.

29. The receiving node according to claim 28, wherein said extended acknowledgement feedback message has multiple potential bit patterns, a unique bit pattern being assigned for each sub-block to indicate a desire for transmission of that sub-block.

30. The receiving node according to claim 29, wherein said extended acknowledgement feedback message has a further potential bit pattern indicating that an entire data block has been correctly received and decoded.

31. The receiving node according to claim 29, wherein said means for selecting which sub-block to set forth for transmission comprises means for determining, when all sub-blocks of said at least one data block have been received but the data block can still not be successfully decoded, which of the sub-blocks to retransmit based on the reception quality of the sub-blocks.

32. The receiving node according to claim 27, wherein said node comprises means for transmitting a feedback message for each of a number of data blocks, and means for aggregating the feedback messages for all these data blocks into a single aggregated bitmap.

33. The receiving node according to claim 32, further comprising means for applying bitmap compression to said aggregated bitmap.

34. A transmitting node for incremental redundancy operation in a wireless communication network, said transmitting node comprising:
means for encoding at least one data block with redundancy and reducing the encoded data block into encoded sub-blocks;
means for transmitting said encoded sub-blocks to the receiving side;
means for receiving, for said at least one data block, information representative of the reception quality of a number of sub-blocks received by the receiving side;
means for selecting, for said at least one data block, which sub-block to set forth for transmission to the receiving side based on the information representative of the reception quality.

35. A transmitting node for incremental redundancy operation in a wireless communication network, said transmitting node comprising:
means for encoding at least one data block with redundancy and reducing the encoded data block into encoded sub-blocks;
means for transmitting said encoded sub-blocks to the receiving side;
means for receiving, for said at least one data block, an extended acknowledgement feedback message indicating which sub-block to set forth for transmission to the receiving side.
